(19) United States
(12) Patent Application Publication
(10) Pub. No.: US 2024/0287847 A1
(43) Pub. Date: Aug. 29, 2024

(54) Automobile Safe

(71) Applicant: Katherine A. Banik, Nashville, TN (US)

(72) Inventors: Katherine A. Banik, Nashville, TN (US); Roy L. Boston, Sugar Grove, IL (US)

(73) Assignee: Katherine A. Banik, Nashville, TN (US)

(21) Appl. No.: 18/113,167

(22) Filed: Feb. 23, 2023

(51) Int. Cl. E05G 1/00; B60R 11/00

(52) U.S. Cl. CPC E05G 1/005; B60R 11/00; B60R 2011/0012; B60R 2011/0049

(57) ABSTRACT

An automobile safe that attaches to anchor loops of an automobile seat comprises a safe enclosure, a safe lid, and one or more engaging members. The safe enclosure has one or more apertures through which the engaging members are disposed. The engaging members have a hook on a first end and a fastening device on a second end, wherein the first end is disposed outside the safe enclosure and the second end is disposed inside the safe enclosure. The hooks engage the anchor loops of the seat, and the fastening members secure the engaging members to the safe enclosure. When the safe is closed and locked, the fastening devices of the engaging members cannot be accessed to disengage from the safe enclosure. Because the engaging members cannot be disengaged from the seat anchors when the lid is closed and locked, the automobile safe cannot be removed from the vehicle.

### FIELD

This invention relates to the field of safes. More particularly, this invention relates to safes for use within automobiles.

### BACKGROUND

Automobile break-ins are common and costly property crimes. In a matter of seconds, thieves can smash windows or pop locks, enter a vehicle, and take whatever they find within. Moreover, automobile gloveboxes and center consoles provide minimal, if any, security. Frequently, these are the first places criminals look. Such structures are usually made of rigid plastic that, even if locked, can be forced open which causes further damage.

An in-automobile safe is one solution. However, conventional safe designs have their drawbacks. Because automobiles are easily broken into, the safe must not be freely removable from the vehicle. Current means of securely installing automobile safes require time, tools, and effort. Additionally, they typically require installers to permanently affix the safe to the vehicle by drilling, screwing, or welding safe components to the vehicle, which is undesirable.

What is needed, therefore, is an automobile safe that can be quickly, easily and removably attached to an automobile without causing permanent modifications to the vehicle structure and without the use of tools, and preferably using strong attachment points that are readily available within the vehicle.

### SUMMARY

The above and other needs are met by an automobile safe that is configured to make use of anchors located within the bight between an automobile seat cushion and backrest, and on the back of the automobile seat. The anchors may be part of a standardized system for securing a child safety seat, referred to as the Lower Anchors and Tethers for Children (LATCH) system. The LATCH system is ubiquitous, in that all automobiles sold in America that were manufactured since 2003 are required to have the anchors in at least two seating positions. Further, the LATCH system is designed to withstand the enormous forces involved in car crashes.

In a preferred embodiment, the automobile safe includes a safe enclosure having an interior. The enclosure has a surface with one or more apertures extending therethrough. An opening in the enclosure provides access to the interior and is covered by a safe lid that is movable between open and closed positions. The safe lid includes a locking mechanism that prevents access to the interior of the enclosure when the lid is closed, and the locking mechanism is locked. The safe also includes one or more engaging members configured to extend through the apertures in the surface of the enclosure. The engaging members each have a first end that is disposed outside the enclosure, and a second end that is disposed within the interior of the enclosure. The first end includes a hook that removably engages a loop that is part of an anchor of the LATCH system, and the second end includes a fastening device. The fastening device secures the engaging member to the safe enclosure from the interior of the enclosure. When the fastening device is secured, the enclosure cannot be disengaged from the anchor of the LATCH system without having access to the interior of the enclosure. Thus, when the safe lid is closed and the locking mechanism is locked, the safe enclosure cannot be disengaged from the LATCH system and removed from the vehicle.

In some embodiments, the locking mechanism is a combination lock, and in other embodiments it is a keyed lock.

In some embodiments, the fastening device of the engaging member is a strap that may be tightened within the safe enclosure.

In some embodiments, the fastening device of the engaging member is a threaded rod and nut, wherein the nut has an outer profile that is larger than the aperture through which the engaging member extends.

In some embodiments, the apertures in the safe enclosure are defined by annular protrusions extending into the safe enclosure, wherein the annular protrusions each have a proximal face. In embodiments in which the fastening device comprises a threaded rod and nut, the nut is threaded onto the threaded rod to contact the proximal face.

### BRIEF DESCRIPTION OF THE DRAWINGS

Other embodiments of the invention will become apparent by reference to the detailed description in conjunction with the figures, wherein elements are not to scale so as to show the details more clearly, wherein like reference numbers indicate like elements throughout the several views, and wherein:

FIG. 1 depicts an automobile seat with anchors, and an exploded view of an automobile safe enclosure, safe lid, and engaging members according to an embodiment of the invention;

FIG. 2 depicts an automobile seat with anchors and automobile safe engaging members according to an embodiment of the invention;

FIG. 3 depicts an automobile safe enclosure with an engaging member disposed within an aperture according to an embodiment of the invention; and

FIG. 4 depicts an automobile safe enclosure, safe lid, and engaging members that are engaged with anchors in an automobile seat according to an embodiment of the invention.

### DETAILED DESCRIPTION

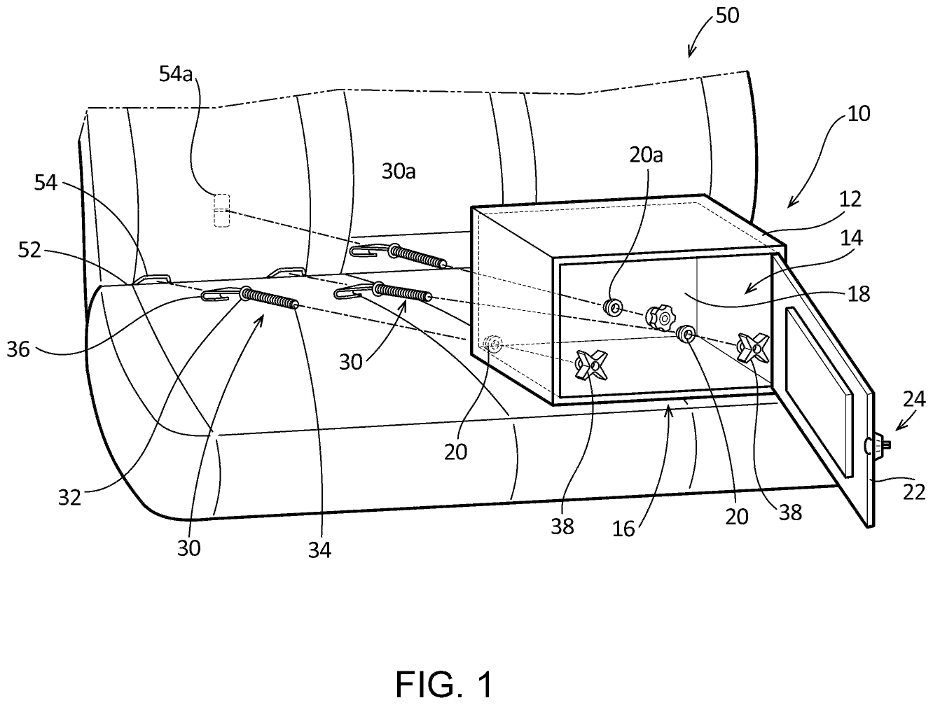

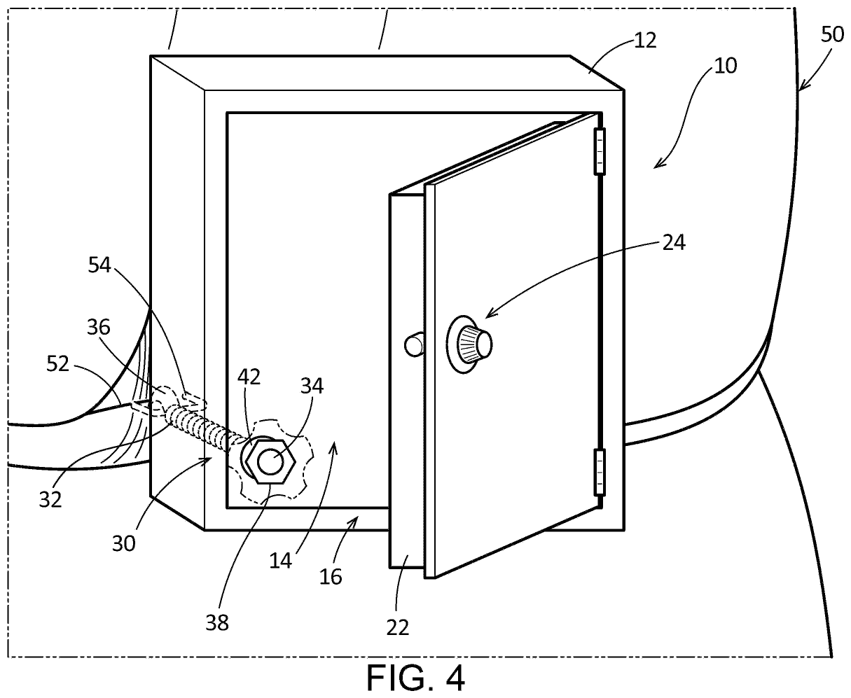

FIG. 1 depicts a preferred embodiment of an automobile safe 10 resting on an automobile seat 50, and anchors 54 located within a seat bight 52 of the automobile seat 50. The automobile safe 10 includes a safe enclosure 12 having an interior 14 in which users may secure valuables or other items. The interior 14 is accessed via an opening 16, which may be covered by a safe lid 22. FIGS. 1 and 4 show the safe lid 22 in an open position. When in a closed position, the safe lid 22 prevents access to the interior 14 by securely covering the opening 16. In the preferred embodiment, the safe lid 22 also comprises a locking mechanism 24. As shown in FIGS. 1 and 4, the locking mechanism 24 may be a combination lock, such as one with a dial or numbered wheels. It will be appreciated that the locking mechanism 24 could take the form of another type of lock, such as a keyed lock. Preferably, all of the components of the automobile safe are made of rigid materials, such as iron, steel, reinforced graphite composites, or any other suitable material that would withstand a break-in attempt.

Although FIGS. 1 and 4 depict the opening 16 and the lid 22 being in a front wall of the safe 10, it will be appreciated that the opening 16 and lid 22 may be in other locations in other embodiments. For example, in one embodiment the opening 16 and lid 22 are in the top surface of the safe 10.

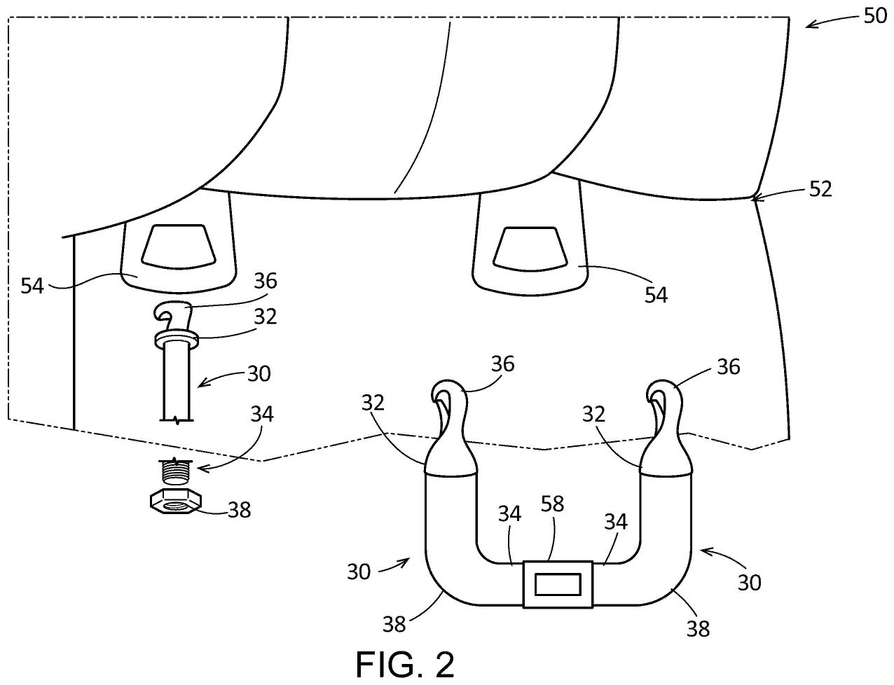

The safe 10 includes engaging members 30 (shown disassembled in FIG. 1) that prevent the safe 10 from being removed from the automobile. In a preferred embodiment, there are two engaging members 30. Each engaging member 30 has a first end 32 that engages an anchor 54 in the seat 50, and a second end 34 that engages the safe enclosure 12. In the preferred embodiment, the first end 32 comprises a hook 36 and the second end 34 comprises a fastening device 38. The engaging members 30 are configured to extend through apertures 20 in a surface 18 of the safe enclosure 12 such that the first end 32 is disposed outside the safe enclosure 12 and the second end 34 is disposed inside the safe enclosure 12. It will be appreciated that the hook 36 and fastening device 38 may take different forms in different embodiments. For example, as shown in FIG. 2, the hook 36 may be an open hook or a hook with a safety latch. The fastening device 38 may be a threaded rod and nut, a strap, a metal cable, or a device similar to a carabiner clip. It will also be appreciated that if the fastening devices 38 are straps, the straps of two engaging members 30 may be tied, belted, buckled, or otherwise secured to each other within the enclosure 12, or secured directly to the enclosure 12. In one embodiment shown in FIG. 2, the straps 38 are connected together at their ends 34 by a buckle 58 that provides for cinching the straps 38 tight for securing the enclosure 12 to the seat 50. It will also be appreciated that in embodiments comprising one or more engaging members 30, a combination of fastening devices 38 may also be used. For example, in one embodiment, the fastening device of one engaging member may be a strap, which may be threaded through the loop of the fastening device of another engaging member, for instance, a carabiner clip, and cinched tight by a buckle.

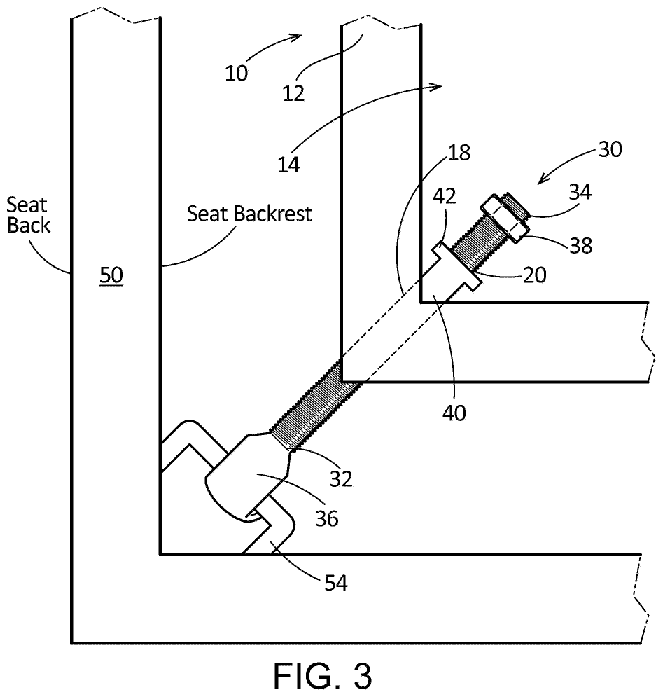

FIGS. 3 and 4 show an embodiment of an assembled engaging member 20 from multiple viewpoints. FIG. 3 depicts an engaging member 30 extending through an aperture 20 in the enclosure 12, with a hook 36 at the first end 32 disposed outside the enclosure 12 engaging an anchor loop 54 in the seat bight. Preferably the apertures 20 are substantially aligned with the position of the anchor loops 54 of the automobile seat 50. The second end 34 of the engaging member 30 is disposed within the interior 14 of the safe enclosure 12 with fastening device 38 engaged. In the embodiments of FIGS. 3 and 4, the engaging member 30 comprises a metal rod that is threaded at second end 34, and the fastening device 38 comprises a nut that threads onto the threaded rod. It will be appreciated that the nut may be a hex-head nut that is tightened with a wrench, or a wing nut, or a nut encased in a knob having a knurled surface that can be tightened by hand. Once the fastening device 38 is secured, the engaging member 30 cannot be disengaged from the safe enclosure 12 without access to the interior 14 of the enclosure.

FIG. 4 depicts a frontal view of the automobile safe 10, wherein an engaging member 30 is engaged with the anchor 54 attached to the seat 50. As noted above, once the fastening device 38 is secured within the interior 14, the engaging member 30 cannot be disengaged from the safe enclosure 12 from outside the enclosure. In FIG. 4, the safe lid 22 is shown in an open position and the locking mechanism 24 is unlocked. However, when the safe lid 22 is moved to a closed position and the locking mechanism 24 is locked, the automobile safe 10 cannot be removed from the vehicle because the safe enclosure 12 cannot be disengaged from the engaging members 30.

In the embodiment depicted in FIG. 3, the apertures 20 may be defined by annular protrusions 40 that extend from the surface 18 into the interior 14 of the enclosure 12. Each annular protrusion 40 has a proximal face 42 that provides a flat surface against which the nut of the fastening device 38 can make contact.

While FIGS. 3 and 4 show an embodiment wherein an engaging member 20 engages anchor loop 54 in a seat bight of automobile seat 50, it will be appreciated that the automobile safe could be configured for use with anchor loops other than those located in an automobile seat bight. The LATCH system also involves anchors loops located on the seat backs of automobile seats, which provide attachment points of similar strength to anchor loops located in the automobile seat bight. In some embodiments, such as shown in FIG. 1, an aperture 20a may be provided through a surface of the enclosure that is adjacent to the seat back of the seat 50. In an exemplary embodiment depicted in FIG. 1, the aperture 20a is not aligned with an anchor loop 54 in the bight of the seat 50, but rather is aligned with an anchor loop 54a located on the seat back. In this embodiment, the automobile safe cannot be removed from the seat back because the safe enclosure 12 cannot be 10 disengaged from the engaging member 30a while the safe lid 22 is closed and locked.

While embodiments described herein are directed to an automobile safe configured to work with preexisting components within an automobile, those skilled in the art of safes will appreciate that the configuration described herein is not limited to use only in automobile applications but may be used in any application in which safes are attached to static components.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. An automobile safe that engages an automobile seat in which one or more anchor loops are disposed, the automobile safe comprising:
a safe enclosure having an interior, an opening that provides access to the interior, and at least one surface having one or more apertures;
a safe lid configured to cover the opening and movable between an open position and a closed position, the safe lid including a locking mechanism configured such that the interior of the safe enclosure is not accessible when the safe lid is in the closed position and the locking mechanism is locked; and
one or more engaging members configured to extend through the one or more apertures in the at least one surface of the safe enclosure, each engaging member having a first end disposed outside the safe enclosure and a second end disposed within the interior of the safe enclosure, the first end comprising a hook and the second end comprising a fastening device,
wherein the hook of each engaging member removably engages one of the one or more anchor loops, and
wherein the fastening device of each engaging member secures the engaging member to the safe enclosure, such that the safe enclosure cannot be disengaged from the engaging member while the safe lid is in the closed position and the locking mechanism is locked.

2. The automobile safe of claim 1 wherein the locking mechanism comprises a combination lock.

3. The automobile safe of claim 1 wherein the locking mechanism comprises a keyed lock.

4. The automobile safe of claim 1 wherein the fastening device comprises a threaded rod and nut, wherein the nut has an outer profile that is larger than the aperture through which the engaging member extends.

5. The automobile safe of claim 4 wherein the apertures are defined by annular protrusions extending into the safe enclosure, wherein the annular protrusions each have a proximal face, and the nut of the fastening device contacts the proximal face when threaded onto the threaded rod.

6. The automobile safe of claim 1 wherein the fastening device comprises a strap secured to the safe enclosure or secured to another fastening device within the safe enclosure.

7. An automobile safe that engages an automobile seat in which one or more anchor loops are disposed, the automobile safe comprising:
a safe enclosure having an interior, an opening that provides access to the interior, and one or more apertures through a surface of the safe enclosure;
a safe lid configured to cover the opening and movable between an open position and a closed position, the safe lid including a locking mechanism configured such that the interior of the safe enclosure is not accessible when the safe lid is in the closed position and the locking mechanism is locked; and
one or more engaging members, each comprising:
a rod that extends through one of the one or more apertures, the rod having a first end disposed outside the safe enclosure and a second end disposed within the interior of the safe enclosure;
a hook disposed at the first end of the rod;
a threaded portion disposed at the second end of the rod; and
a nut having threads matching the threaded portion of the rod, and having an outer profile that is larger than the aperture through which the rod extends,
wherein the hook of each engaging member removably engages one of the one or more anchor loops, and
wherein the nut on the threaded portion secures the engaging member to the safe enclosure, such that the safe enclosure cannot be disengaged from the engaging member while the safe lid is in the closed position and the locking mechanism is locked.

8. The automobile safe of claim 7 wherein the locking mechanism comprises a combination lock.

9. The automobile safe of claim 7 wherein the locking mechanism comprises a keyed lock.
